(19) United States
(12) Patent Application Publication
(10) Pub. No.: US 2011/0265663 A1
(43) Pub. Date: Nov. 3, 2011

(54) BARBECUE OVEN

(76) Inventor: Yongde Li, Guangdong (CN)

(21) Appl. No.: 13/128,570

(22) PCT Filed: Nov. 10, 2008
(86) PCT No.: PCT/CN2008/001860

§ 371 Date: Jul. 21, 2011

(51) Int. Cl. A47J 37/07

(52) U.S. Cl. 99/446; 126/25 R

(57) ABSTRACT

A barbeque oven comprises an oven body, a fire source provided on the oven body and a barbeque grill, wherein an oil receiving device is provided between the fire source and the barbeque grill. The oil receiving device comprises an oil receiving baffle plate, an oil guiding groove and an oil collecting pot. The oil receiving baffle plate is provided as a corrugated plate or a flat plate obliquely mounted. A plurality of flame penetrable apertures are provided on the corrugated oblique surface of the corrugated plate or in the flat plate. An aperture covering device is provided above said flame penetrable aperture, wherein said aperture covering device is provided as a bevel sheet with its upper edge in connection with the corrugated oblique surface or the flat plate. A spacing is provided between the aperture covering device and the flame penetrable apertures. The oil guiding groove is obliquely mounted under the lower edge of the oil receiving baffle plate, and the mouth of the oil collecting pot corresponds to the lower end of the oil guiding groove for oil collection. Flame or heat of fire can reach up to the foods and barbeque them through the flame penetrable apertures in the oil receiving baffle plate and the spacing between the flame penetrable apertures and the aperture covering device, while the oil from barbecue and/or grease drippings when barbecuing will fall onto the oblique oil receiving baffle plate and flow to the oil collecting pot by means of the oil guiding groove. This avoids the oil from barbecue and/or grease drippings when barbecuing from falling onto the fire source.

### TECHNICAL FIELD

The present invention relates to a barbecue oven, and more particularly, to a barbecue oven capable of avoiding smoke caused by oil or grease drippings from falling onto a fire source when barbequing.

### BACKGROUND ART

Food barbequing has a long history. Food barbequing originates from the use of fire as humans have evolved into modern people. Barbequed food has a flavor that is beloved by people.

A prior art barbecue oven generally comprises an oven body, a fire source arranged above the oven body and a barbecue grill. The fire source may consist of firewood, charcoal, oil or electric energy. The barbecue grill is usually directly arranged over the fire source so as to make full use of the ascending heat generated by the fire source. The disadvantages of such a barbecue oven are that oil applied to food during barbequing and grease drippings from some foods after being heated, will sometimes fall directly onto the fire source, thereby generating smoke which may rise up to the foods and be inhaled by the barbequers. It is well known that smoke is bad for human health and pollutes the environment, and smoke from foods will render people susceptible to cancer. To prevent the oil and grease drippings from falling onto the fire source, some barbecue ovens are provided with two rows of upright electrothermal plates, between which foods are placed for barbequing. This solution is complicated in structure and low in thermal efficiency, has limitations in the placement of foods to be barbequed and cannot completely prevent grease drippings from falling onto the fire source.

### SUMMARY OF THE INVENTION

In view of the shortcomings in the prior art, the technical problem to be solved by the present invention is to provide a barbecue oven capable of avoiding oil and grease drippings from barbecue from falling onto the fire source.

To solve the above-mentioned technical problem, the present invention can be achieved by the following technical solution:

a barbeque oven comprising an oven body, a fire source provided on the oven body and a barbeque grill above the fire source, characterized in that said oven body is also provided with an oil receiving device between the fire source and the barbeque grill, wherein the oil receiving device comprises an oil receiving baffle plate, an oil guiding groove and an oil collecting pot, wherein the oil receiving baffle plate is obliquely mounted and has a plurality of flame penetrable apertures thereon, wherein an aperture covering device is arranged above the flame penetrable apertures, and wherein a spacing is provided between the aperture covering device and the flame penetrable apertures, wherein the oil guiding groove is obliquely mounted under the oblique lower edge of the oil receiving baffle plate; and wherein the mouth of the oil collecting pot corresponds to the lower end of the oil guiding groove for oil collection.

In this case, flame or heat of fire can reach up to the foods and barbeque them through the flame penetrable apertures in the oil receiving baffle plate and the spacing between the flame penetrable apertures and the aperture covering device, while the oil for barbecue will fall onto the obliquely mounted oil receiving baffle plate and finally flow to the oil collecting pot by means of the oil guiding groove, which avoids the oil from barbecue from falling onto the fire source. The oil receiving baffle plate and the aperture covering device of the barbeque oven according to the present invention can be in various forms:

the oil receiving baffle plate is made of a corrugated plate or a flat plate, wherein the flame penetrable apertures are openings in the corrugated oblique surface of the corrugated plate or in the flat plate;

the aperture covering device is provided as a bevel sheet with the upper edge thereof in connection with the corrugated oblique surface of the corrugated plate or the oblique surface of the flat plate;

the aperture covering device is provided as a top cover supported by at least two posts and larger than the flame penetrable aperture, wherein an upwardly convex annular edge is provided around the flame penetrable apertures of the oil receiving baffle plate; wherein the convex annular edge is capable of preventing oil from barbecue having fallen on the oil receiving baffle plate from dripping through the apertures, while the top cover that is larger than the flame penetrable aperture is capable of making the oil from barbecue on the top cover fall onto the oil receiving baffle plate outside of the flame penetrable aperture;

the top cover is provided as a tapered shell-like top cover facing downwards;

the top cover is provided as an invertedly arranged bowl-like inverted top cover, wherein the posts for support are provided as channel-section posts with outward facing notches, wherein each of the parts of the bowl floor plate corresponding to the top end of the posts is provided with a bowl bottom aperture; wherein the inverted wall of the bowl-like top cover is inclined upwardly in such a way that the flame can go up therealong, while the oil for barbecue having fallen in the bowl can flow through the bowl bottom apertures provided in the bowl floor plate along the channel-section posts with the outward facing notches to the exterior of the annular edges provided around the flame penetrable apertures;

the oil receiving baffle plate is sheet-like and is wholly obliquely mounted;

the oil receiving baffle plate is provided as a four-sided pyramidal shell or multi-sided pyramidal shell;

the oil receiving baffle plate is provided as a conical shell with the vertex upwards;

the oil receiving baffle plate is provided as a conical frustum shell with the vertex thereof downwards and partially intercepted, so that the received oil for barbecue flows to a circular hole formed by intercepting a part of the vertex in the center of the conical frustum shell, wherein the fire source is not arranged on the oven body just under the circular hole, wherein the oil guiding groove is slantingly mounted below the circular hole of the oil receiving baffle plate, and the mouth of the oil collecting pot corresponds to the lower end of the oil guiding groove for oil collection.

In contrast with the prior art, the advantageous effect of the present invention is to avoid generation of smoke caused by the oil from barbecue and/or grease drippings when barbecuing falling onto the fire source due to the oil receiving baffle plate arranged between the fire source and the barbeque grill.

### DESCRIPTION OF THE DRAWINGS

FIG. 1 is an exploded perspective view illustrating the structure of an embodiment of a barbecue oven;

FIG. 2 is a partial cross sectional view of the barbecue oven taken along line A-A of FIG. 1;

FIG. 3 is a partial cross sectional view of the barbecue oven taken along line B-B of FIG. 1;

FIG. 4 is an enlarged partial cross sectional view of a first type of oil receiving baffle plate;

FIG. 5 is a view of the baffle plate of FIG. 4 viewed in C direction;

FIG. 6 is a cross sectional view of the portion of a second type of oil receiving baffle plate wherein flame penetrable apertures are provided;

FIG. 7 is a cross sectional view of the baffle plate taken along line D-D of FIG. 6;

FIG. 8 is a cross sectional view of a portion of a third type of oil receiving baffle plate wherein flame penetrable apertures are provided;

FIG. 9 is a top view of the baffle plate of FIG. 8;

FIG. 10 is a cross sectional view of the baffle plate taken along line E-E of FIG. 8;

FIG. 11 is a perspective view of a fourth type of oil receiving baffle plate;

FIG. 12 is a perspective view of a fifth type of oil receiving baffle plate;

FIG. 13 is a side elevation view of the baffle plate of FIG. 12;

FIG. 14 is a perspective view of a sixth type of oil receiving baffle plate;

FIG. 15 is a side elevation view of the baffle plate of FIG. 14;

FIG. 16 is a cross sectional view of various aperture covering devices on an oil receiving baffle plate made of a flat sheet.

Wherein: 1—oven body, 2—fire source, 3—barbecue grill, 4—oil receiving baffle plate, 5—oil guiding groove, 6—oil collecting pot, 7—flame penetrable aperture, 8—aperture covering device, 9—spacing, 10—convex annular edge, 11—tapered shell-like top cover, 12—invertedly arranged bowl-like top cover, 13—channel-section post, 14—bowl bottom aperture, 16—oblique surface, and 17—bevel sheet.

### DETAILED DESCRIPTION OF THE EMBODIMENTS

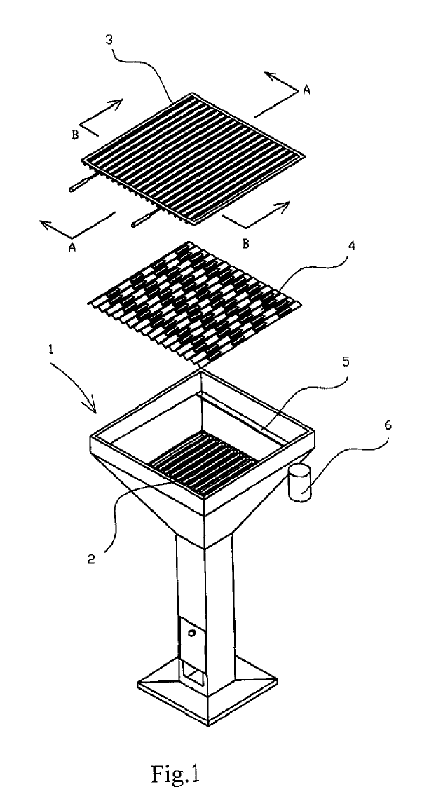

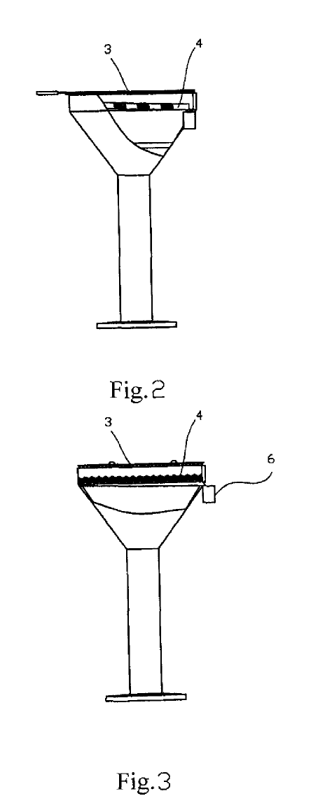

As shown in FIGS. 1 to 5, a barbecue oven of the present invention comprises an oven body 1, a fire source 2 above the oven body and a barbeque grill 3 above the fire source, and an oil receiving device arranged between the fire source 2 and the barbeque grill 3 consisting of a first type of oil receiving baffle plate 4, an oil guiding groove 5 and an oil collecting pot 6.

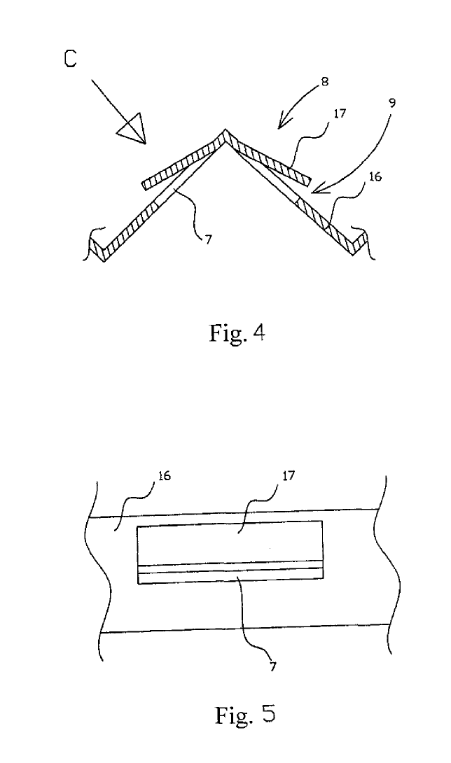

The first type of oil receiving baffle plate 4 is a sheet-like rectangular corrugated plate, the full sheet mounted slightly obliquely with one side higher and one side lower so as to facilitate the flow of the oil from barbecue or grease drippings having fallen on the oil receiving baffle plate 4 to the lower side. The oil receiving baffle plate 4 is provided with a plurality of flame penetrable apertures 7 that are on the oblique surfaces 16 of the corrugated plate, and an aperture covering device 8 provided above the flame penetrable aperture 7 with a spacing 9 between the aperture covering device 8 and the flame penetrable aperture 7. The aperture covering device 8 of the first type of oil receiving baffle plate 4 of this embodiment is a bevel sheet 17 with its upper edge in connection with the corrugated oblique surface, as shown in FIGS. 4 and 5. The oil guiding groove 5 is slantingly mounted below the oblique lower side of the oil receiving baffle plate 4 for receiving the oil from barbecue or grease drippings flowing along the surface of the oblique oil receiving baffle plate 4 and guiding the oil from barbecue or grease drippings to the oil collecting pot 6, and the mouth of the oil collecting pot 6 corresponds to the lower end of the oil guiding groove 5 for oil collection at that place.

The oil receiving baffle plate 4 of this embodiment may be also made of a flat plate with the flame penetrable apertures 7 opened on the oblique surface of the flat plate, which also functions to baffle and collect oil.

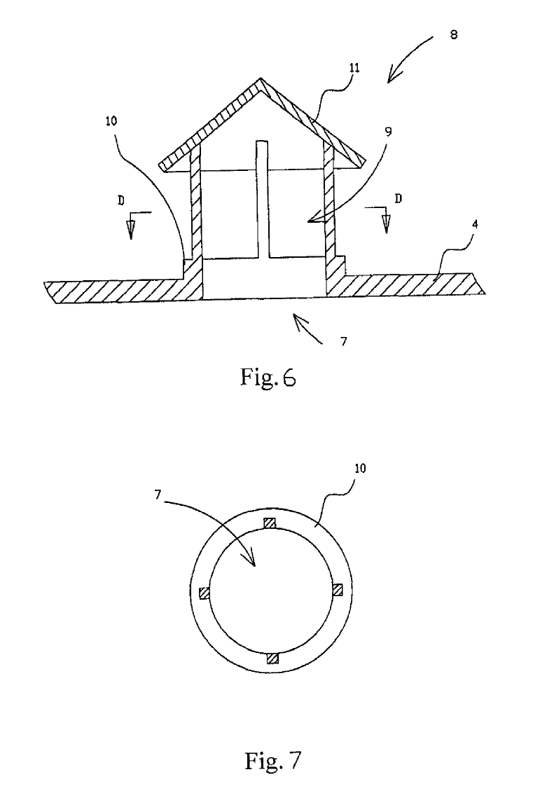

On the basis of above embodiment, the oil receiving baffle plate 4 may also have other variants, for instance, a second type of oil receiving baffle plate as shown in FIGS. 6 and 7. Similarly, the oil receiving baffle plate 4 may be made of a corrugated plate or a flat plate with the flame penetrable apertures 7 opened on the corrugated oblique surface 16 of the corrugated plate or on the oblique surface of the flat plate.

The second type of oil receiving baffle plate has the flame penetrable apertures 7 with an upwardly convex annular edge 10. The aperture covering device 8 is a tapered shell-like top cover 11 supported by four posts. The aperture covering device 8 is larger than the flame penetrable aperture 7 and opens downwards.

The convex annular edge 10 may prevent the oil having fallen on the oil receiving baffle plate 4 from dripping through the flame penetrable apertures 7, and the top cover that is larger than the flame penetrable aperture 7 will make the drippings on the top cover fall onto the oil receiving baffle plate 4 outside of the flame penetrable apertures 7.

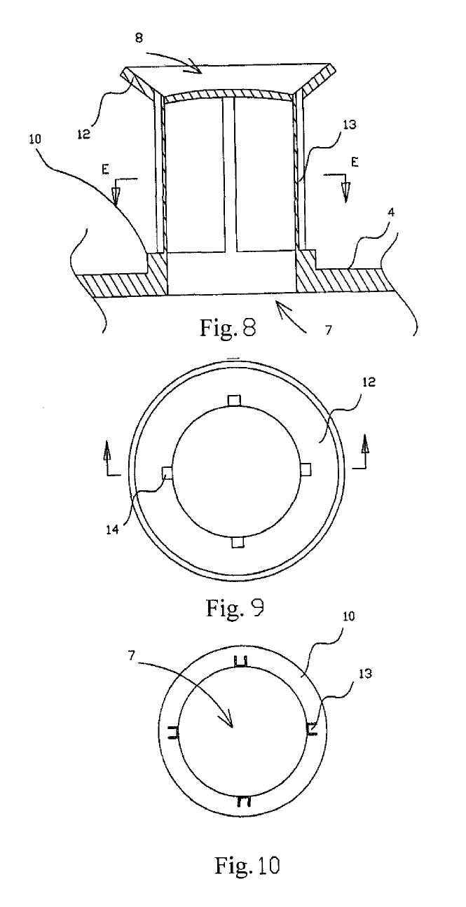

As shown in FIGS. 8 to 10, a third type of oil receiving baffle plate 4 is made of a corrugated plate or a flat plate with the flame penetrable apertures 7 opened on the corrugated oblique surface 16 of the corrugated plate or on the oblique surface of the flat plate. The upwardly convex annular edge 10 is provided around the flame penetrable aperture 7, and the aperture covering device 8 is an invertedly arranged bowl-like top cover 12 supported by four posts, and which is larger than the flame penetrable aperture 7. The support posts are channel-section posts 13 with outward facing notches, and the area of the bowl floor plate corresponding to the top end of the post is provided with bowl bottom apertures 14.

Since the bowl edge is inclined upwards, the flame can go up therealong. Oil having fallen within the bowl can flow through the bowl bottom apertures provided in the bottom of the bowl and then flow along the channel-section posts with the outward facing notches to the exterior of the annular edges of the flame penetrable apertures.

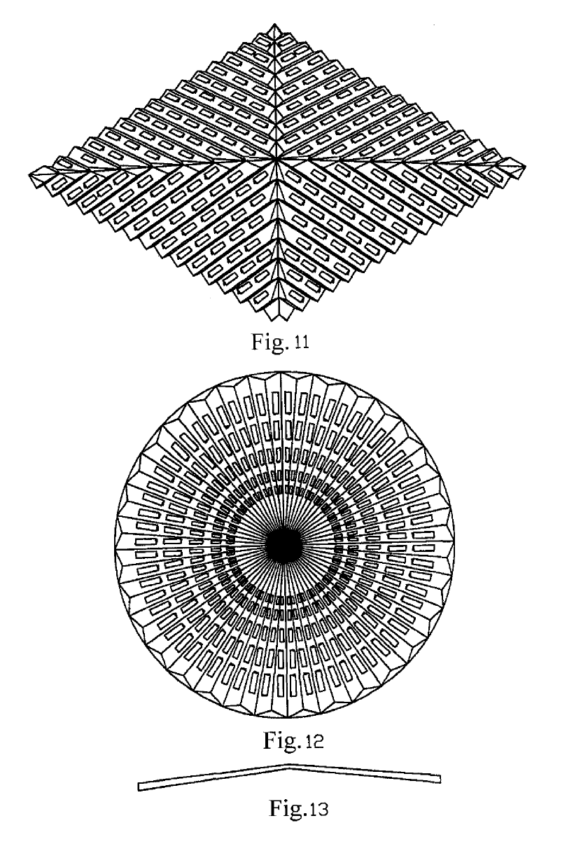

FIG. 11 is a perspective view of a fourth type of oil receiving baffle plate, which differs from the first embodiment in that the oil receiving baffle plate 4 is a four-sided pyramidal shell, and the received oil from barbecue when barbecuing flows along the four oblique pyramidal surfaces of the pyramidal shell and is guided to the oil collecting pot 6 by the oil guiding groove 5 slantingly mounted below the lower sides of the four pyramidal surfaces.

The oil receiving baffle plate 4 of this embodiment may also be made of four flat plates with the flame penetrable apertures 7 opened on the four pyramidal surfaces, which may also function to baffle and collect oil.

FIGS. 12 and 13 are perspective views of a fifth type of oil receiving baffle plate, which differs from the first embodiment in that the oil receiving baffle plate 4 is a conical shell with the vertex upwards, and the received oil from barbecue flows along the oblique conical surface and is guided to the oil collecting pot 6 by the oil guiding groove 5 slantingly mounted below the lower sides of the conical surface. The oil receiving baffle plate 4 of this embodiment may also be made of a flat plate.

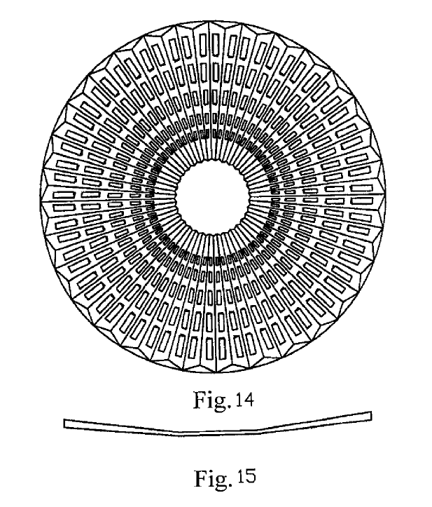

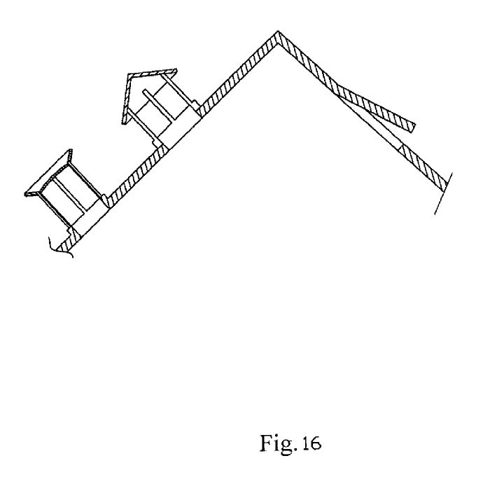

FIGS. 14 and 15 are of a sixth type of oil receiving baffle plate, which differs from the fifth embodiment in that the oil receiving baffle plate 4 is a truncated conical shell with the vertex downwards and partially intercepted. The received oil from barbecue flows to a circular hole formed by partially intercepting the vertex in the center of the truncated conical shell. The fire source is arranged at the oven body so that it is not under the circular hole. The oil guiding groove is slantingly mounted below the circular hole of the oil receiving baffle plate, and the mouth of the oil collecting pot corresponds to the lower end of the oil guiding groove for oil collection.

The oil receiving baffle plate 4 of all of the above embodiments is made of a corrugated plate with the flame penetrable apertures 7 opened on the corrugated oblique surface 16 of the corrugated plate. The oil receiving baffle plate 4 may also be made of a flat plate with the flame penetrable apertures 7 directly opened on the surface of the flat plate. Since the flat plate is mounted obliquely, the aperture covering device may also be configured in the form of a bevel sheet with its upper edge in connection with the obliquely mounted flat plate for achieving the object of the present invention.

The oil receiving baffle plate can not only be a sheet-like or four-sided pyramidal shell, a conical shell with the vertex upwards, a conical shell with the vertex downwards and partially intercepted, a flat plate, but also a gable-roof made by two corrugated plates or flat plates lapped, or a six-sided pyramidal shell or an eight-sided pyramidal shell. Any type of the oil receiving baffle plate is applicable as long as it conforms to the shape of the oven body, and has oblique surfaces allowing the received oil from barbecue to flow therealong and is provided with flame penetrable apertures and provided with the aperture covering devices.

1. A barbecue oven, comprising
an oven body,
a fire source above said oven body, and
a barbeque grill above said fire source,
wherein said oven body comprises an oil receiving device arranged between said fire source and said barbeque grill, said oil receiving device comprising
an oil receiving baffle plate having a plurality of flame penetrable apertures, said oil receiving baffle plate obliquely mounted,
an oil guiding groove slantingly mounted below the oblique lower side of said oil receiving baffle plate,
an oil collecting pot having a mouth, the mouth of said oil collecting pot corresponding to the lower end of said oil guiding groove for oil collection, and
an aperture covering device provided above said flame penetrable aperture with a spacing between said aperture covering device and said flame penetrable apertures.

2. The barbecue oven according to claim 1, wherein said oil receiving baffle plate comprises a corrugated plate with said flame penetrable apertures opening on the corrugated oblique surface of said corrugated plate.

3. The barbecue oven according to claim 2, wherein said aperture covering device is a bevel sheet having an upper edge in connection with said corrugated oblique surface of said corrugated plate.

4. The barbecue oven according to claim 2, wherein said aperture covering device comprises a top cover, said top cover including an upwardly convex annular edge around said flame penetrable apertures of said oil receiving baffle plate, and further comprising at least two posts for supporting the top cover.

5. The barbecue oven according to claim 4, wherein said top cover is a tapered shell-like top cover facing downwards.

6. The barbecue oven according to claim 4, wherein said top cover is an invertedly arranged bowl-like inverted top cover, wherein the posts for support comprise channel-section posts with outward facing notches, and wherein each of the parts of said bowl floor plate corresponding to the top end of said posts has a bowl bottom aperture.

7. The barbecue oven according to claim 3, wherein said oil receiving baffle plate is sheet-like and is wholly obliquely mounted to one side.

8. The barbecue oven according to claim 3, wherein said oil receiving baffle plate is a four-sided pyramidal shell or a multi-sided pyramidal shell.

9. The barbecue oven according to claim 3, wherein said oil receiving baffle plate is a conical shell with the vertex thereof upwards.

10. The barbecue oven according to claim 3, wherein said oil receiving baffle plate is a conical frustum shell with the vertex thereof downwards.

11. The barbecue oven according to claim 1, wherein said oil receiving baffle plate comprises a flat plate with said flame penetrable apertures opening on the oblique surface of said flat plate obliquely mounted.

12. The barbecue oven according to claim 2, wherein said aperture covering device is a bevel sheet having an upper edge in connection with the oblique surface of said flat plate.
